(19) United States
(12) Patent Application Publication
(10) Pub. No.: US 2024/0180132 A1
(43) Pub. Date: Jun. 6, 2024

(54) Fishing Lure

(71) Applicant: Jesse Steinbeck, Allegan, MI (US)

(72) Inventor: Jesse Steinbeck, Allegan, MI (US)

(21) Appl. No.: 18/075,692

(22) Filed: Dec. 6, 2022

(51) Int. Cl. A01K 85/00

(52) U.S. Cl. CPC A01K 85/1893; A01K 85/1827

(57) ABSTRACT

The Steinbeck Smart Lure is the only product of its kind that has the capability of mimicking the real-life movements of a wide variety of different animals as well as capturing live footage of the fish attacking the bait all in effort to employ modern technologies to the aspect of fishing. This unprecedented device is uniquely designed with advanced mechanisms in each animal model that will kick, swim, bend, and move in the water, perfectly simulating the typical movements of an animal in the water, with vivid colors and excellent articulation. Furthermore, this device uses a propeller that works in complement with an independent battery permitting automatic swimming functionality and offers a waterproof accessory as the battery unit, GPS and camera features are coated in protective layer ensuring long term sustainability.

### BACKGROUND

Electric lures are great devices for attracting any type of fish, and can make the overall pastime of fishing a lot easier. Current designs of electronic lures, however have seen little to no improvement over the years and have yet to incorporate any modern features that may improve their functionality. There have been no products available as original equipment or as an aftermarket to address this problem.

A more realistic electric lure apparatus that is long lasting product to withstand sharp teeth and elements, with a better battery life and attracts any type of fish, is not being met by any known device or system at present. There have been no products available as original equipment or as an aftermarket to address this problem either.

### SUMMARY OF THE INVENTION

The main purpose of the disclosure is to provide users with a self-swimming fishing lure possessing a built-in camera fish finder that facilitates improving catch results.

A fishing lure device including a fishing lure having a head and an extremity, a spine embedded in the fishing lure configured as a mechanical conduit for a flexion wave motion and as a conduit for an electrical communications therein, at least one electric motor configured to generate the flexion wave motion along the spine from the head to the extremity thereof, and a controller circuit in communication with the at least one electric motor.

### BRIEF DESCRIPTION OF THE DRAWINGS

FIG. 1 is a top view of a lizard fishing lure in accordance with an embodiment of the present disclosure.

FIG. 2 is a top view of a snake fishing lure in accordance with an embodiment of the present disclosure.

FIG. 3 is a top view of a frog fishing lure in accordance with an embodiment of the present disclosure.

FIG. 4 is a top view of a crawfish fishing lure in accordance with an embodiment of the present disclosure.

FIG. 5 is a front view of a duckling fishing lure in accordance with an embodiment of the present disclosure.

FIG. 6 is a side view of a section of the spine vertebrae acting as a mechanical and electrical conduit for motion and communications in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

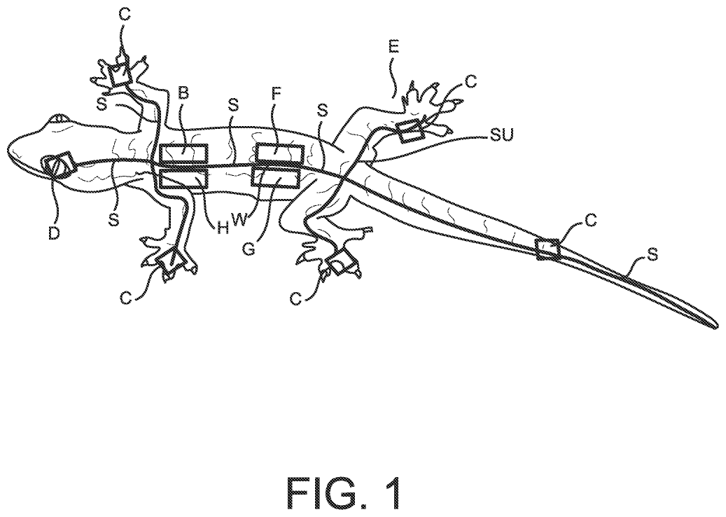

FIG. 1 is a top view of a lizard fishing lure: showing controller circuit and printed circuit board referenced as B, camera referenced as D, lizard lure referenced as E, battery referenced as F, GPS (global positioning satellite) referenced as G, fish finder referenced as H, and motor referenced as C in accordance with an embodiment of the present disclosure. Wire W carries electrical communication through out the fishing lure and is embedded in the spine vertebrae.

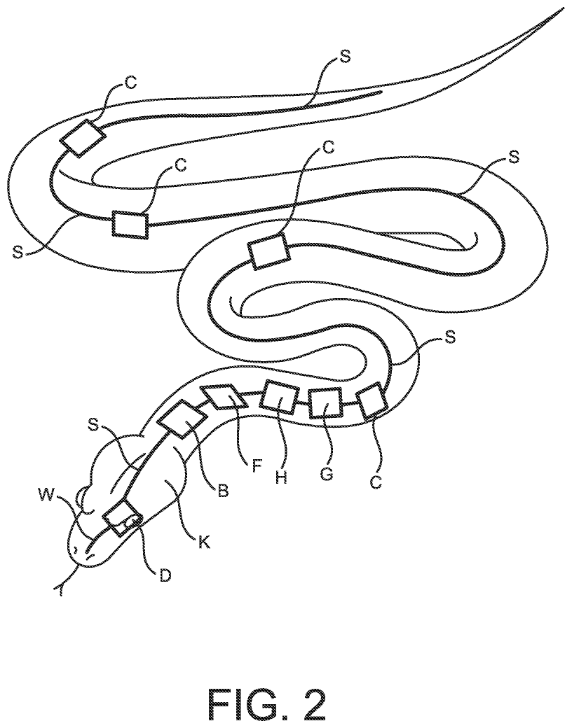

FIG. 2 is a top view of a snake fishing lure showing: showing controller circuit and printed circuit board referenced as B, camera referenced as D, battery referenced as F, GPS referenced as G, fish finder referenced as H, snake lure referenced as K, and motor C such as a stepper motor and a micro motor in accordance with an embodiment of the present disclosure. Wire W carries electrical communication through out the fishing lure and is embedded in the spine vertebrae.

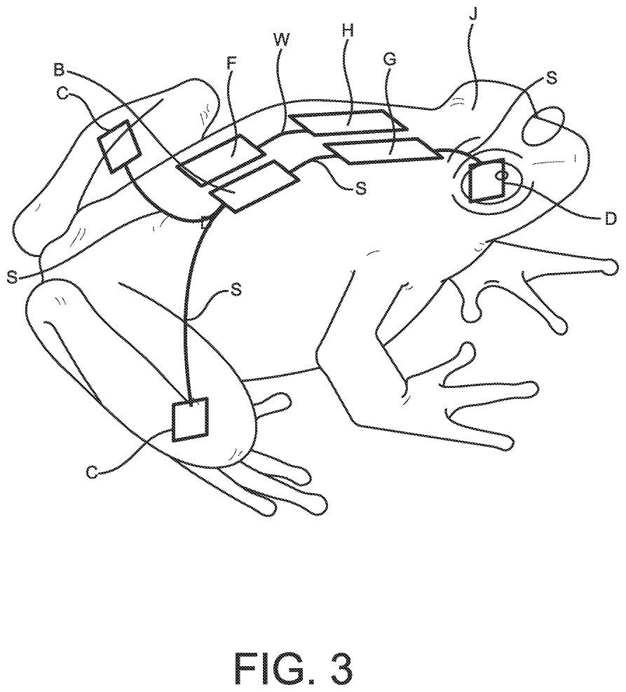

FIG. 3 is a top view of a frog fishing lure showing: circuit board referenced as B, camera referenced as D, battery referenced as F, GPS referenced as G, fish finder referenced as H, frog lure referenced as J, in accordance with an embodiment of the present disclosure. Wire W carries electrical communication through out the fishing lure and is embedded in the spine vertebrae.

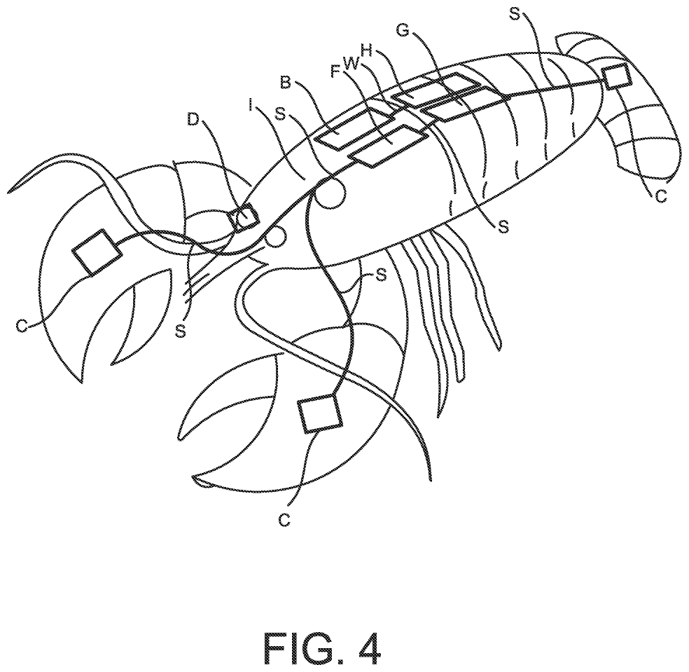

FIG. 4 is a top view of a crawfish fishing lure showing: circuit board referenced as B, camera referenced as D, battery referenced as F, GPS referenced as G, fish finder referenced as H, crawfish lure referenced as I, in accordance with an embodiment of the present disclosure. Wire W carries electrical communication through out the fishing lure and is embedded in the spine vertebrae.

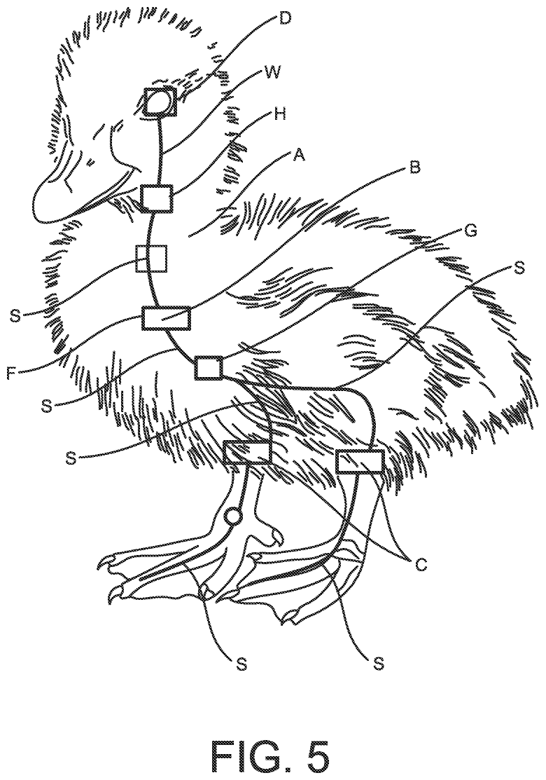

FIG. 5 is a front view of a duckling fishing lure showing: duckling lure referenced as A, circuit board referenced as B, camera referenced as D, battery referenced as F, GPS referenced as G, fish finder referenced as H, in accordance with an embodiment of the present disclosure. Wire W carries electrical communication through out the fishing lure and is embedded in the spine vertebrae.

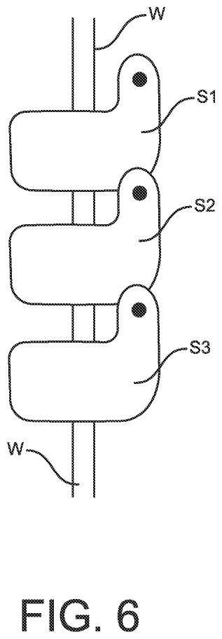

FIG. 6 is a side view of a section of the spine vertebrae acting as a mechanical and electrical conduit for motion and communications in accordance with an embodiment of the present disclosure. The view includes the spinal vertebrae S1, S2 and S3 interconnected and flexible around pivot points P. The wire or wires W carry electrical communication among the component parts of the disclosure and runs through a central portion thereof.

The present disclosed fishing lure, also known as “The Steinbeck Smart Lure”, offers a modern lure that not only simulates the movements of an animal to attract predator fish, but also enables users to physically watch how the fish react to the bait on the lure via a camera. This unique design improves catch ratio and allows for a more enjoyable fishing experience. Expanding on the initial design-n of an average electronic lure, The Steinbeck Smart Lure introduces a novel camera strategically placed onto the self-propelling fishing lures that are electronically programmed to mimic the life-like movement patterns of either a snake, frog, crawfish, duckling, or lizard. With advanced technology, users will be able to connect their lures to their smartphone devices, via a mobile app, and watch the live footage of the fish attacking the bait on the lure. To further enhance functionality, The Steinbeck Smart Lure is equipped with cutting-edge GPS that enables individuals to conveniently locate their lures in the case that they are misplaced and/or lost. This innovative, top-quality product ensures a fully operational self-propelling fishing lure that incorporates Avant-garde features allowing for sportsman to experience a more entertaining, and productive fishing excursion.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A fishing lure device comprising:
a fishing lure comprising a head and an extremity;
a spine embedded in the fishing lure configured as a mechanical conduit for a flexion wave motion and as a conduit for an electrical communications therein;
at least one electric motor configured to generate the flexion wave motion along the spine from the head to the extremity thereof; and
a controller circuit in communication with the at least one electric motor.

2. The fishing lure device of claim 1, further comprising a direct current battery in electrical communication with the spine.

3. The fishing lure device of claim 1, further comprising a global positioning satellite (GPS) circuit in electrical communication with the spine.

4. The fishing lure device of claim 1, further comprising a fish finder circuit in electrical communication with the spine.

5. The fishing lure device of claim 1, further comprising a camera in electrical communication with the spine.

6. The fishing lure device of claim 1, further comprising a plurality of wires in the spine configured to carry out the electrical communications.

7. The fishing lure device of claim 1, wherein the fishing lure is a duckling.

8. The fishing lure device of claim 1, wherein the fishing lure is a lizard.

9. The fishing lure device of claim 1, wherein the fishing lure is a crawfish.

10. The fishing lure device of claim 1, wherein the fishing lure is a frog.

11. The fishing lure device of claim 1, wherein the fishing lure is a snake.

12. The fishing lure device of claim 1, wherein the controller circuit further comprises a wireless transmitter in communication with the at least one electric motor and a remote control.

13. The fishing lure device of claim 1, wherein the controller circuit comprises a state machine circuit design.

14. The fishing lure device of claim 1, wherein the controller circuit comprises a programmable state machine design.

15. The fishing lure device of claim 1, wherein the controller circuit comprises a microprocessor circuit design.

16. The fishing lure device of claim 1, wherein the extremity is a foot.

17. The fishing lure device of claim 1, wherein the extremity is a claw.

18. The fishing lure device of claim 1, wherein the extremity is a tail.

19. The fishing lure device of claim 1, wherein the extremity is a fin.

20. The fishing lure device of claim 1, wherein the spine comprises interconnected sections of hard plastic similar to a vertebrae.
